(19) United States
(12) Patent Application Publication
(10) Pub. No.: US 2024/0354801 A1
(43) Pub. Date: Oct. 24, 2024

(54) Method and System for Managing Purchasing Rewards

(71) Applicant: Wallet Warrior, Inc, Pittsburgh, PA (US)

(72) Inventor: Frank Halstead Brown, IV, Pittsburgh, PA (US)

(73) Assignee: Wallet Warrior, Inc, Pittsburgh, PA (US)

(21) Appl. No.: 18/642,406

(22) Filed: Apr. 22, 2024

Related U.S. Application Data
(60) Provisional application No. 63/461,371, filed on Apr. 24, 2023.

(51) Int. Cl. G06Q 30/0226

(52) U.S. Cl. CPC G06Q 30/0233

(57) ABSTRACT

This is a system for optimizing purchasing rewards, comprising a rewards management system data lake comprising a user database and a merchant database, wherein the user database is configured to store a plurality of purchasing options, and the merchant database is configured to store merchant data, wherein the merchant data comprises a merchant classification and transaction classification. The system comprises an optimization engine configured to analyze, periodically, the plurality of purchasing options against the merchant data to produce a reward value for each purchase option against the merchant type and the transaction type, and generating, periodically, a lookup table to rank the plurality of purchasing options based on the reward value. The system further comprises a transaction application programming interface configured to receive a transaction input, wherein the transaction input comprises a merchant code and a transaction code, evaluate the transaction input by matching the merchant code against the merchant classification and matching the transaction code with the transaction classification, identify an optimized purchasing option from the plurality of purchasing options in the lookup table, wherein the optimized purchasing option comprises the highest reward value, and generate a transaction output for the optimized purchasing option.

### BACKGROUND

Every day, millions of American credit card holders leave reward value on the table by failing to use the credit card that they already possess which would grant them the largest reward and/or lacking the credit cards that are best suited to maximize the reward potential based on their individual spending habits. There exists a need for a way for consumers to maximize return on their purchases without expanding excessive effort for research and planning.

The present method and system provide a solution to this problem by ensuring that, at the time of the transaction, the consumer can select the payment method that will maximize user rewards for the transaction at hand and facilitate the completion of the transaction. As the user spends over time, additional recommendations would be made based on the user's own spending habits that would increase their reward-earning potential.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a computer-implemented method for optimizing purchasing rewards is provided. The method comprises obtaining a plurality of purchasing options and storing into a user database, obtaining merchant data and storing into a merchant database, wherein the merchant data comprises a merchant classification and transaction classification, analyzing the plurality of purchasing options against the merchant data to produce a reward value for each purchase option against the merchant type and the transaction type, generating, periodically, a lookup table to rank the plurality of purchasing options based on the reward value, receiving a transaction input, wherein the transaction input comprises a merchant code and a transaction code, evaluating the transaction input by matching the merchant code against the merchant classification and matching the transaction code with the transaction classification, identifying an optimized purchasing option from the plurality of purchasing options in the lookup table, wherein the optimized purchasing option comprises the highest reward value, and generating a transaction output for the optimized purchasing option.

In various other implementations, a system for optimizing purchasing rewards is provided. The system comprises a rewards management system data lake comprising a user database and a merchant database, wherein the user database is configured to store a plurality of purchasing options, and the merchant database is configured to store merchant data, wherein the merchant data comprises a merchant classification and transaction classification. The system comprises an optimization engine configured to analyze, periodically, the plurality of purchasing options against the merchant data to produce a reward value for each purchase option against the merchant classification and the transaction classification, and generating, periodically, a lookup table to rank the plurality of purchasing options based on the reward value. The system further comprises a transaction application programming interface configured to receive a transaction input, wherein the transaction input comprises a merchant code and a transaction code, evaluate the transaction input by matching the merchant code against the merchant classification and matching the transaction code with the transaction classification, identify an optimized purchasing option from the plurality of purchasing options in the lookup table, wherein the optimized purchasing option comprises the highest reward value, and generate a transaction output for the optimized purchasing option.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a block diagram of a rewards management system in accordance with the subject disclosure.

FIG. 2 is an exemplary user access process of the rewards management system in accordance with the subject disclosure.

FIG. 3 is an exemplary embodiment of a reward data sourcing network for the rewards management system in accordance with the subject disclosure.

FIG. 4 is an exemplary embodiment of additional sourcing network for the rewards management system in accordance with the subject disclosure.

FIG. 5 is an exemplary embodiment of an optimization batch process for the rewards management system in accordance with the subject disclosure.

FIG. 6 is an exemplary embodiment of an online transaction experience using the rewards management system in accordance with the subject disclosure.

FIG. 7 is an exemplary embodiment of an in-person transaction experience using the rewards management system in accordance with the subject disclosure.

FIG. 8 is an exemplary embodiment of savings center, card analyzer, and card recommendation engine for the rewards management system in accordance with the subject disclosure.

FIG. 9 is an exemplary embodiment of a trip planner for the rewards management system in accordance with the subject disclosure.

FIG. 10 is an exemplary process utilizing the rewards management system in accordance with the subject disclosure.

### DETAILED DESCRIPTION

The subject disclosure is directed to a method and system for maximizing purchase rewards. The exemplary embodiment focuses on purchasing rewards centered primarily on credit card purchases, but it is envisioned that the present method and system is adaptable to other consumer purchasing methods. Generally, the present method and system index purchasing methods of a consumer, such as credit cards, in order to evaluate optimal purchasing method for each transaction. A database is populated with merchant data to specifically identify how each transaction would be applied based on the purchasing method's reward criteria, wherein the evaluation is periodically generated and updated for faster process time at checkout. The method and system would then generate a recommendation to the consumer as to which purchasing method would produce the optimal reward for the transaction. The present method and system keep track of potential rewards across all purchasing methods of the consumer in order to maintain up-to-date evaluation of purchasing options and potentials.

The rewards management system and method utilizes analysis on user data, purchasing option data, and merchant data to identify the most optimized purchasing option. The system comprises a central data repository that is designed to be fluidly re-configurable, and capable to storing and organizing data from a plethora of sources concurrently. A user database stores both a user's data (such as biographic information, purchasing habit, transaction preferences) and purchasing options (such as a variety of credit cards, gift cards, or reward certificates). A merchant database stores retailer information and merchant category codes. The rewards management system utilizes an analytical algorithm to identify how a transaction would be classified for each purchasing options. The analytical algorithm will identify the correct rewards for each purchasing option in accordance with the classification of the transaction by the financial institution for each purchase option. As such, the rewards management system can accurately assess the reward amount for each transaction, wherein the user would be able to always choose the purchasing option that would maximize reward return for the transaction.

The rewards management system and method utilizes the analytical algorithm to create a plurality of temporary lookup tables in associating purchasing options with the potential transactions. This is done to accelerate the evaluation process at the moment of transaction. In the exemplary embodiment, this allows the system to output optimization recommendations instantaneously, rather than carrying out the processing at the point of transaction. It is envisioned that the creation of temporary lookup tables is done during typically inactive period for a user, such as during night time. The frequency of the analysis can be customized based on the user's spending habit and lifestyle. This provides for both flexibility and efficiency to better accommodate the user experience.

The rewards management system and method can be implemented on existing platforms or dedicated platforms, in the form of web browser extensions, mobile applications, software programs, or API plug ins. The rewards management system comprises a physical card with wireless networking capabilities, wherein the physical card can embody the recommended purchasing option. Thus, a user can foreseeably carry only one card for optimized purchasing experiences. The rewards management system enables a user to eliminate the need to carry around a plethora of payment options. It is further envisioned that the associated physical card can be securely transitioned to embody multiple purchasing options without compromising safety concerns. In various embodiments, the rewards management system provides a purchasing output in the form of payment hardware, such as tap to pay via mobile phones or personal computing devices. The present system is envisioned to integrate with appropriate payment hardware to further maximize payment rewards without the need to carry all the payment options on the user's person.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such a feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independent modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

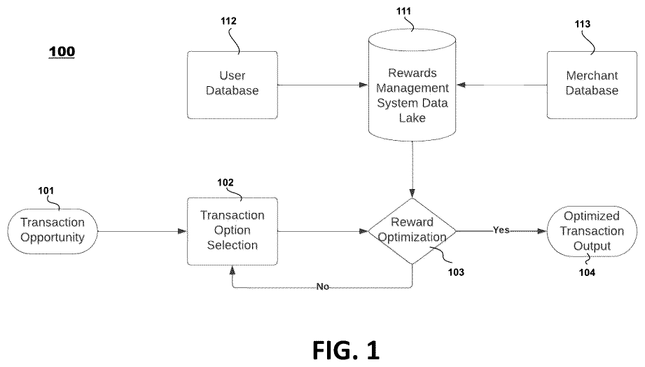

Now referring to the drawings and particularly to FIG. 1, various features of the subject disclosure are now described in more detail with respect to a rewards management system and method. The purchasing reward optimization system, generally designated as 100, comprises a rewards management system data lake 111 and a reward optimization module 103. The reward optimization module 103 is connected to a transaction option selection module 102, which directly correspond to a transaction opportunity input 101. The rewards management system data lake 111 comprises a user database 112 and a merchant database 113. The reward optimization module 103 is further connected to an optimized transaction output 104. In the exemplary embodiment, each of the components is implemented as a part of an application programming interface (API), which can be embodied as a mobile application, a web browser extension, a standalone software program, etc.

When a user decides to make a purchase, the user enters the purchase condition into the transaction opportunity input 101. The transaction opportunity input 101 is programmed to collect information regarding the transaction, such as retailer information and merchant classification code (MCC), in order to facilitate the purchasing reward analysis. A number of purchase options, either pre-selected by the user or selected at the moment of transaction, are evaluated through the reward optimization module 103. The reward optimization module 103 considers datasets within the rewards management system data lake 111 in order to evaluate the pertinent purchase options. The rewards management system data lake 111 comprises user database 112 and merchant database 113. The user database 112 stores and organizes data such as user bio info, purchase history, purchase reference, purchase options (including credit card, gift card, and rewards program information). The merchant database 113 stores and organizes data pertaining to the retailers and service providers, which can further be identified and organized by geographical location. The merchant database 113 contains information such as retailer basic information, merchant category code, and additional classification identifiers for relevant transactions.

The reward optimization module 103 utilizes data from the rewards management system data lake 111. In an exemplary embodiment, the reward optimization module 103 generates a lookup table that ranks each purchasing option contained in the user database 112 against data in the merchant database 113. The ranking can be done against each merchant classification code, further organized by each retailer. The ranking can also be done against the holistic rewards of each purchasing option, without considering the merchant classification or transaction classification. Merchant and transaction classification would comprise identification of the merchant and transaction, as well as type of transaction, whether specific to the merchant. The lookup table provides an effective way to identify the purchasing option with the highest return or reward value for each transaction type. In the exemplary embodiment, the reward optimization module 103 generates and updates the lookup tables during the inactive period of a user's day. Typically, this would be during late nights, such as beginning at 2 am-3 am. In various other embodiments, the user can select timeframes during which the reward optimization module 103 can update the lookup tables. In various other embodiments, the rewards management system 100 analyzes a user's transaction history recorded in the user database 112 to identify the proper period for lookup table updates.

The periodic optimization lookup table generation and update provides at least one advantage. This allows near instant data retrieval at point of transaction, which eliminates complication of running an optimization analysis immediately prior to purchasing. This also provides the user with an opportunity to review the purchase option rankings in the lookup table manually at the start of each day. This planned frequency is important to support a seamless user transaction experience in the long-term. In various embodiments, the lookup tables can be generated within the rewards management system data lake 111 that is accessible through a wireless network. The lookup tables can then be accessed through the network at each point of purchase for expedited analysis. In various other embodiments, the lookup tables are downloaded onto each user device upon completion. Therefore, the reward optimization process can partially be enabled through local devices, without requiring wireless networks to function.

The reward optimization module 103 processes the purchasing option selected by the user at transaction option selection 102, if applicable, against reward option lookup tables generated from the rewards management system data lake 111, and generates an optimized transaction output 104. The output can be a recommendation of the purchase option, in an exemplary embodiment. The output can embody a purchasing option, additionally, in various implications. As such, the optimized transaction output 104 can enable tap-to-pay functions that are associated with mobile devices. In various other embodiments, the optimized transaction output 104 is implemented into a physical card with wireless capabilities. In such configurations, the optimized transaction output 104 replaces traditional payment and allows maximized carrying freedom of the user, without having to carry and search among multiple purchase options. The reward optimization module 103 repeats the process for the purchase options should the option not be considered maximized.

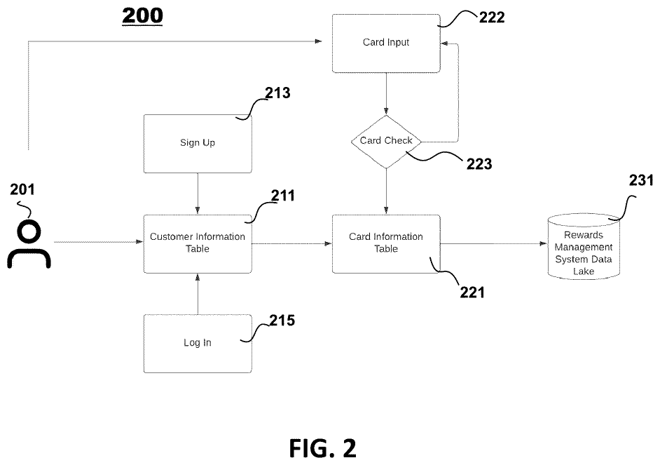

Referring to FIG. 2, an exemplary process of a user's experience in accessing the rewards management system is generally designated 200. In this exemplary embodiment, the user 201 interacts with an embodiment of the rewards management system through an interaction, such as a mobile app or a web browser. The user 201 will first download the mobile app from an app store applicable to their operating system (iOS, Android, etc.) or will be directed from an online landing page to download a browser extension on one or more web app stores. When the user 201 opens the application for the first time on either mobile or web, the user 201 will be met with a “Sign-Up” screen 213. When the user 201 signs-up for the first time, their basic personal information will be captured, including first and last name, and email address, and then they will need to create a password. The rewards management system provides authentication means to verify the user 201's access. In an exemplary embodiment, an authentication link is then sent to the user 201's email address for verification.

In various embodiments, the present system leverages existing frameworks for user authentication and authenticated session management. Onboarding our application with these frameworks enables users to sign-up via traditional email and password, or leverage existing accounts with Google/Apple for account creation. In various other embodiments, the rewards management system leverages an Authorization Service (such as, Auth0) to allow users to utilize their existing Google or Apple accounts to seamlessly sign-up and sign-in for the service.

Upon verification, a designated alphanumeric customer ID is assigned and enters all of this information into the Customer Information Table 211. The Customer Information Table 211, along with all of the other database tables, will be stored in a single data repository, the Rewards Management System Data Lake 231. If the user 201 already has a profile or account created with the present system, the user 201 can access the system through log in 215. Each user's information will be associated with a universally unique identifier (UUID). The UUID is also utilized extensively in the rewards management system data lake 231.

In this exemplary embodiment, the system leverages Amazon's AWS DynamoDb, a fully managed NoSQL database service that allows creation of key-value tables. All relevant Rewards Management System data is housed in these different DynamoDb tables, giving us a single data warehouse/truth source for all channels of the Rewards Management System 200. Each of the tables utilized in the system application and referenced in this document, whether they are accessed via mobile or web interface, will all be stored in this single repository 231. This will lead to a seamless, synchronized mobile and web experience and will allow for consolidated code bases, increasing operational efficiency.

For users that have already signed up for use of the Rewards Management System, the “Sign-Up” screen 213 and “Log-In” screens 215 are connected to one another. When an existing user logs in, their credentials will be checked in the Customer Information Table 211, and they will be granted or denied access to a session. If the log-in is successful, the associated customer ID will be linked to any action the user takes while in the mobile app or web portal until they log out voluntarily or are logged out automatically due to inactivity.

After a user 201 has signed-up up for purchase reward optimization system 200 and been verified, they can begin adding purchasing options. The user 201 can add their debit, gift, store reward, and credit cards to the card information table 221. The card information table 221 behaves as a digital wallet, wherein all purchasing options associated with the user 201 are stored and organized in one place. The card information table is configured to record a plurality of purchasing options. The user 201 can manually add these purchasing options through a card input 222, which is accessible via both web and mobile, by typing in the card information. In various other embodiments to help make card addition easier on mobile, the rewards management system 200 is configured to enable taking a picture of the card with the user 201's mobile device camera and have the card information auto-populate for addition to the card information table 221.

From a data standpoint, for each user 201, each card that is added will receive an alphanumeric wallet ID which will be recorded in the card information table 221, along with the card's 16-digit card number, the expiration date of the card, the CVV on the back of the card, and the date that card was added to the wallet or digital wallet. When the user 201 adds a card to the card information table 221 using the card input 222, a card check engine 223 will aim to establish a link between the card in the individual user's card information table 221 with an internal list of cards that the purchase reward optimization system 200 tracks. The card information table 221 is configured to monitor card reward rates and special offers. The card check engine 223 is configured to check whether the card the user 201 is adding is already tracked within the card information table 221. If so, a link will be established in the database. If the card is not tracked, an alert is sent to initialize coverage and begin data sourcing on the card product in question.

In an exemplary embodiment, the user information stored in the customer information table 211 comprises name and email of the user 201. Users 201 are given a unique alphanumeric identifier, and the user data contains a list of separate unique alpha-numeric identifiers that correspond to the purchasing options associated with the user 201. These alphanumeric identifiers uniquely identify a record defining general information about a card, but not information specific to any user 201. In various other embodiments specific information of each purchase option can be utilized for the rewards management system to enable payments as an output.

The rewards management system 200 supports users scanning their cards via mobile phone camera to add cards to their digital wallet, in an exemplary embodiment. While scanning enables identifying a user's unique card information (what type of card it is, what network it runs on, what issuer it belongs to, the cardholder's name, card number (PAN), card verification value (CVV), and expiration date), the rewards management system is configured to verify that the card and its rewards are modeled in the card information table 221. In another embodiment, the scanning of the card using card input 222 would either trigger a notification to the managing portal of the rewards management system 200 to add the card, or trigger a separate system of reward data management to automatically scrape information about the card from the web and attempt to add it to the rewards management system data lake 231.

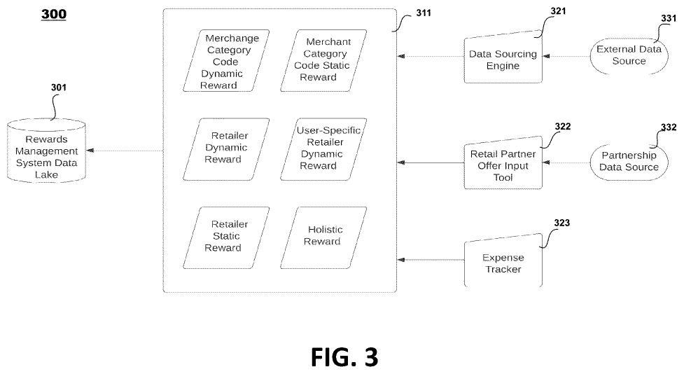

Referring to FIG. 3, the merchant database implementation of the rewards management system is generally designated 300. In the exemplary embodiment, data will be collected from external sources to populate merchant data in the rewards management system data lake 301. This sourcing is done in a number of ways. For data residing in external data sources, such as those of the financial institutes or retailers, a data sourcing engine 321 is utilized. The data sourcing engine 321 is configured to use web scraping to capture rate information and reward constraints, intrinsic to specific cards, from publicly available disclosures on external data sources 331. The external sourcing can be accomplished manually as well as through automated data population processes broadly applied for both merchant information and card information.

The retail partner offer input tool 322 is utilized to obtain data from partnership data sources 332. This allows financial institutes, retailers, and participating merchants to input their specific merchant classification data and transaction identifiers. For rewards that are specific to a certain user based on their own spending, the retail partner offer input tool 322 is configured to source this data through a financial institution's API in accordance with a strategic partnership. In at least one embodiment, an expense tracker 323 can be implemented to track specific individual spending classified by the user.

The data sourcing engine 321, retail partner offer input tool 322, and expense tracker 323 feed data into the reward data table 311. The collected data within the reward data table 311 in support of optimization engine can be organized into six internally-defined categories, but they can all be stored within the same data table. The UUID applicable to the user data can also be utilized to facilitate organization of various merchant data within the merchant data table 311.

The reward data table 311 comprises merchant category code dynamic rewards. These are rewards that are specific to certain spending categories (eg. Groceries, Restaurants, Gas Stations, etc.) as defined by merchant classification codes (MCCs). For this specific type, the focus is on reward rates that change over time, hence the “dynamic” moniker, such as Discover's quarterly rotating categories (5% cash back on groceries and pharmacies in 1Q23, 5% cash back on restaurants and bars in 2Q23, etc.)

The reward data table 311 comprises Merchant Category Code Static Reward Data. Just as above, these are rewards that are specific to certain spending categories, yet these rates do not change over time. This would include cards like the Capital One Savor Card which yields 4% cash back at restaurants, or the PNC Cash Rewards card which provides 4% cash back on gasoline, regardless of the transaction date.

The reward data table 311 comprises Retailer Dynamic Reward Data. Similar to the dynamic reward rates outlined above by MCC, these rewards, instead of focusing on spending categories, are aligned to specific merchants or retailers. One example would be Discover's It Card offering 5% cash back at Amazon.com in 4Q22. We will establish partnerships with businesses to provide users special offers if they pay using our app to complete a transaction. To capture the terms of these offers and their durations, we will have a Retail Partner Offer Input Tool (322) for partners and our team to add the terms of new offers. Offers that change over time will be captured in this table.

The reward data table 311 comprises User-Specific Retailer Dynamic Reward Data. Much like the previously mentioned retailer dynamic reward rates, these rewards are offered directly by financial institutions to customers based on individual customer spending. An example would be PNC offering a user 15% cashback with a $15.00 maximum at Hello Fresh from now until Mar. 31, 2023 when using PNC's Cash Rewards Visa. This type of reward information would need to be sourced directly from the providing institution via its API.

The reward data table 311 comprises Retailer Static Reward Data. Like the static MCC reward rates outlined above, these rewards, instead of focusing on spending categories, are aligned to specific merchants or retailers. One example would be Target's Red Card, which provides 5% cashback on all purchases at Target, or the Amazon Prime Rewards Visa Signature Card which provides 5% cashback on all purchases at Amazon.com and Whole Foods. The merchant data table 311 also enables partner businesses to capture unchanging offers in this table.

The reward data table 311 comprises Holistic Static Reward Data. This category of reward data is essentially the “everything else” category. Here the system captures the reward rates for cards that fall outside of specific MCC or retailer rewards. For instance, the Capital One Savor card provides the cardholder with 1% cash back on all other purchases outside of restaurants, groceries, and retailer-specific rewards. A better option, if a user had this card in their wallet, would be the Citi Double Cash Card or Wells Fargo Active Cash card, which both earn 2%. This is an important segment of the model, as there are many transactions that will not have cards dedicated to the applicable retailer or MCC (eg. paying a large medical bill at UPMC or buying new tires for one's car at an independent mechanic). While travel point conversion will be discussed later in this document, the system will capture point conversions for travel-focused cards, such as Amex Platinum, Chase Sapphire, or airline-specific cards as, while these cards have mediocre holistic rates generally, the points they earn can usually be converted into travel rewards at an effective rate of 3.5% or more, making them useful to meet a user's specific travel spending needs. This will be addressed further in relation to the Expense Tracker 323.

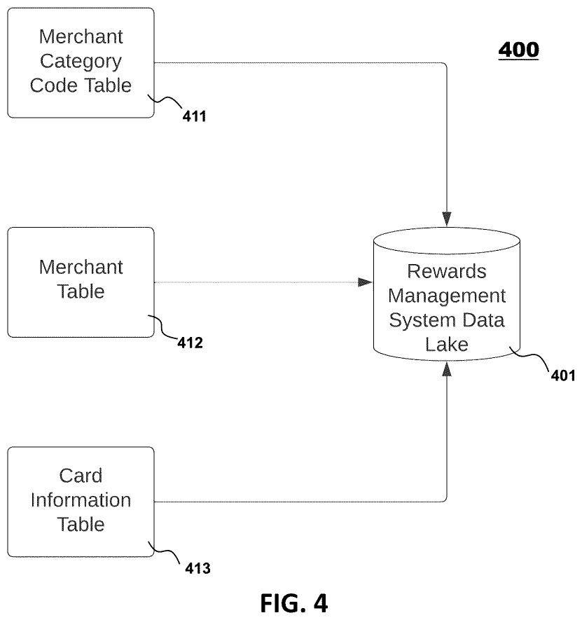

Referring to FIG. 4, additional data organization is generally designated 400. In addition to the rewards table 311 in FIG. 3, the rewards management system data lake 401 also comprises a custom list of merchant classification codes in a merchant category code table 411, and a list of merchants in a merchant table 412, along with numerical identifiers for each corresponding entry. This will enable the linking of merchants and merchant categories to transactions and reward rates. The rewards management system data lake 401 further comprises a card information table 413, which can be used to link cards owned by the user and cards associated with the relevant retailers and merchants.

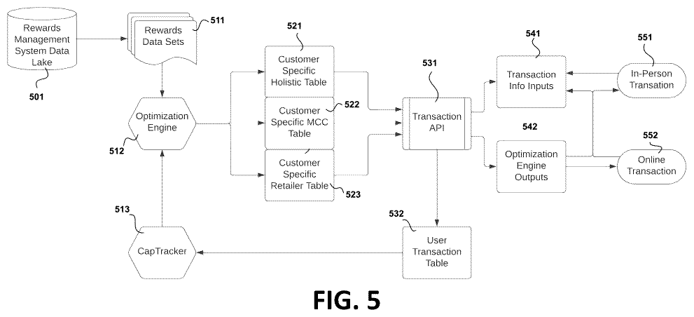

Referring to FIG. 5, an optimization process utilizing the rewards management system is generally designated 500. The rewards management system comprises an optimization engine 512 that is configured to analyze the reward performance of each card during various transactions. The optimization engine 512 utilizes rewards data sets 511 (such as those present in the reward data table 311 in FIG. 3) from the rewards management system data lake 501. The optimization is configured to evaluate the reward data sets 511 and produce a number of lookup tables ranking each purchasing option. The lookup tables in the exemplary embodiment comprise a customer specific holistic table 521, a customer specific MCC table 522, and a customer specific retailer table 523. Additional lookup tables can be added to accommodate specific applications. The lookup tables feed into a transaction API 531, which is the interface for the user during purchase transactions. The transaction API 531 receives transaction info inputs 541 and produces optimization engine outputs 542.

Periodically, the optimization engine 512 will run a process where it identifies the user's card with the highest reward points. This process can be done at a predetermined time each night in the exemplary embodiment. However, this period can be customized to accommodate the particular lifestyle of the user. In general, this process is carried during an inactive time during the user's day. While this is typically in the late night for a person, the user can set a specific time for the process to carry out. In an alternative embodiment, the rewards management system analyzes the user's spending pattern to determine an inactive timeframe automatically. By running delta checks on rewards and then doing an optimization batch job at the user level at each designated time, the system identifies the optimal rates available to the user by category/merchant. These would be teed up for them to use and conduct super-fast queries during the active timeframe This will be important to support a seamless user transaction experience in the long-term.

Furthermore, the optimization batch job can be performed in a cloud computing network, or on a dedicated server reserved for the purchasing reward optimization system. The result of the process can be downloaded onto the local memory of the user device. This allows the user to access the decision-making function of the present system without relying on network connectivity.

The process comprises identifying the purchasing option, or card, in this particular embodiment, with the highest holistic rate through the customer specific holistic table 521 for transactions where there is no greater MCC or retailer-specific reward rate. In the exemplary embodiment, the rewards management system 500 queries for all rewards recorded in the card information table 221 as in FIG. 2 and then at the application level runs a Python script to determine the highest holistic rate for each purchasing option. The holistic rewards are recorded in the customer specific holistic table 521. The identified holistic rate is compared to the rewards rate in the customer specific MCC table 522 and customer specific retailer table 523, wherein the card with the greatest reward value is identified by the optimization engine 512.

In another embodiment, the rewards data sets 511 are organized in a dynamic SQL environment. The rewards management system is configured to retrieve all of a given user's cards from DynamoDb in a batch operation leveraging the AWS Python SDK (Boto3). The Reward Management System then traverses this list of retrieved cards to determine the optimal reward. In the case of no valid merchant-specific or issuer category rewards, the highest holistic reward (i.e 5% on all else, etc.) will be chosen.

In various embodiments, the reward management system batch-gets all the cards/purchase options in the rewards management data lake 501 and identifies the full list of rewards associated with the rewards data sets 511. Concurrently or in parallel, the optimization engine 512 validates a reward. This can be achieved by reconciling that a reward and the merchant information (whether that is the direct merchant name or MCC/issue category) are in alignment. From the list of the validated rewards, the optimization 512 chooses the max value.

As an example, the card identified in the customer specific MCC table 522 would receive the highest reward for purchasing groceries, while the card identified in the customer specific retailer table 523 would receive the highest reward for shopping in a specific retailer. These two cards may not be the same, and the optimization engine 512 would analyze the particular transaction for an upcoming purchase and decide which option would offer the highest reward. This is also checked against the card identified in the customer specific holistic table 521 in the event that a card with holistic reward overperforms either of the MCC or retailer specific cards.

Once the optimization engine 512 has identified the optimal card that the user has in their respective card information table for each merchant category and each retailer, those relationships will be recorded in the customer specific MCC table 522 and customer specific retailer table 523 respectively by using Python scripts that execute commands to create or replace the data in those temporary tables with new MCC and retailer reward rate information where applicable. The commands can be carried out leveraging the software development kit (SDK) enabled by a cloud hosted database, such as the Amazon Web Services (AWS). A person skilled in the arts is envisioned to adapt the rewards management system to an SDK for a cloud-hosted database. The optimization engine 512 is implemented to carry out its function through operations/queries on the data present on the cloud-hosted database.

When a user transacts, their mobile or web devices will use queries via the transaction API 531 on the customer specific MCC table 522 and the customer specific retailer table 523, along with whatever single highest holistic rate was identified in the customer specific holistic table 521, to ensure that for any user transaction the following day, the user will be using the card that grants them the greatest possible reward. The queries can be implemented as operations on data present on the cloud-hosted database, such as one that the rewards management system data lake 501 and the rewards data sets 511 reside on. The queries will leverage identifying information for the retailer the user is at, along with the MCC that the retailer falls under, to determine what card and associated reward rate should be used. The use of these temporary tables 521-523, instead of having the optimization engine query all the reward tables at the time of the transaction, will ensure a lightning-fast decision for the user when they are making purchases. With most of the optimization information calculated the proceeding period in the optimization engine 512 batch process outlined previously, the look-up process at the time of the transaction will be much more efficient. As many optimal outcomes will not change over a 12-24 hour period, a delta check is ran and only updates the reward rates that have changed in the rewards data sets 511 (stemming from new card coverage added, changes in user-specific retailer offers, rotating rewards category dates, etc.). If a card is added to the card information table between batched optimization engine 512 runs, the system will perform an ad-hoc analysis and append the results of the newly added card to the tables 521-523. If the card is not tracked by the present system, it will be included in optimization engine 512 batch run the following day once data has been sourced.

In various embodiments, a delta check is performed by the system during the optimization engine 512 batch runs. In this exemplary embodiment, it is presumed that the system has the capability to stream in updates to reward rates from the web or partnerships with issuers (such as American Express, Capital One, Discover, etc.) and checks for deltas against what was stored the prior period.

In various embodiments, the system is configured to account for the failure mode of a user adding a new credit card between optimization engine 512 runs. With this approach, a one-time refresh of the user's daily tables would occur to account for the addition of the new card's rates without waiting for a regularly scheduled batch job to pick them up the following cycle.

The rewards management system comprises a cap tracker 513, which restricts the optimization engine 512 to only leverage reward rates that have not met a reward cap. The cap tracker 513 will leverage transaction data stored in a user transaction table 532, which will track the transaction history of users along with the rewards they earn from each transaction. As an example, the Discover It Card rewards 5% cashback for all transactions in 1Q23 for MCCs relating to grocers and pharmacies until a maximum of $75.00 cashback is reached. After this cap is hit, the card rewards the user with a holistic rate of 1% cashback on subsequent purchases in these categories. The cap tracker 513 will ensure that, if the user has met their $75.00 cap, then the next best alternative, for example the Capital One Savor card with 3% cashback on groceries, will be used instead. The logic will use a Boolean cap hit Y/N query to impose this restriction. In an exemplary embodiment, the rewards management system utilizes PDF, CSV, or direct API connections with financial institutions or transaction aggregators (such as Plaid, Yodlec, Stripe, etc.) to source legacy transaction data.

The optimization is interacted by the user through the transaction API 531, which comprises transaction info inputs 541 and optimization engine outputs 542. The rewards management system can be utilized by in-person transaction 551 and online transaction 552. In each of these transactions, the user can interact with the rewards management system via the transaction info inputs 541 and optimization engine outputs 542.

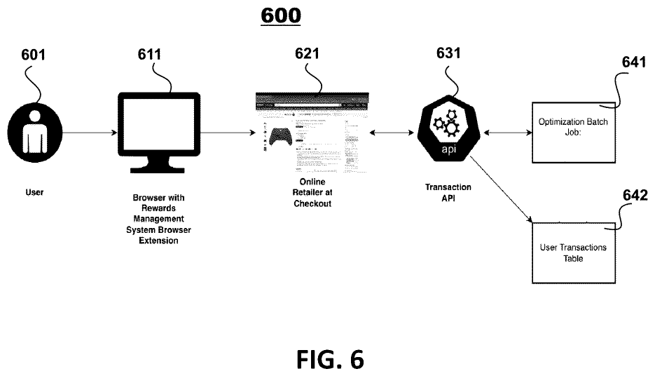

Referring to FIG. 6, an online transaction utilizing the rewards management system is generally designated 600. The process 600 illustrates the web experience of conducting a purchase with a web browser extension enabled by the purchasing reward optimization system. In this scenario, the user 601 is using a browser with the rewards management system browser extension 611 installed and is about to check out while on an online retailer's website 621. When the user 601 is ready to complete the purchase, the rewards management system transaction API 631 collects the retailer and MCC information pertaining to that website. The API 631 then performs a quick query on the user's reward tables looking for the optimal rate for the relevant retailer and its merchant category. The query is implemented as an operation on a cloud-hosted database, in the exemplary embodiment. For example, the query can be implemented through SDK-AWS. The reward tables can be the customer specific MCC table 522, the customer specific retailer table 523, and the customer specific holistic table 521 in FIG. 5. The optimization engine in the rewards management system then takes the highest of the rates and compares that rate to the user's highest holistic rate. If the MCC or merchant rate returned is higher, the information of the card that yielded that rate will be sent to the API to complete the transaction. If the holistic rate is higher than the higher of the two MCC or merchant rates, then the holistic rate's respective card information will be sent to the API to complete the transaction.

The collection of merchant, retailer, and their respective MCC information pertaining to a specific website is only relevant to the browser extension channel, in the exemplary embodiment. Merchant and MCC identification in the physical world will be based on map integrations and user confirmations in app or, if possible, interaction with a merchant's point-of-sale terminal directly.

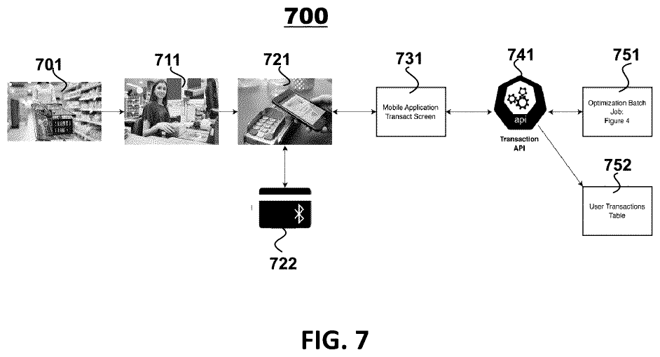

Referring to FIG. 7, an in-person transaction utilizing the rewards management system is generally designated 700. This process illustrates the mobile transaction experience using the example of a trip to the grocery store. Here, the user 701 has filled their grocery cart and has approached the cash register 711. The user 701 has decided to use the rewards management system to complete the purchase. The application may utilize the existing tap-to-pay hardware in iPhone and Android devices 721. In another embodiment, the rewards management system enables users to add their cards to card information table and execute a command from the system app to pay with the optimal card stored in Apple/Google Wallet App, if applicable. In another embodiment, the rewards management system comprises a reward optimization card 722. The reward optimization card 722 is capable of wireless connection and interfaces with the rewards management system app on the user's mobile devices 721. The reward optimization card 722 is designed to enable tap-to-pay, swipe, and insert functionality. This card 722 will essentially take the form of the card that the app's API indicates is best suited for the transaction. The app then passes that card's information to our card to complete the transaction. When any of the previously mentioned mobile or hardware options are placed against the card reader, the user 701 interacts with an interface to confirm their intent to transact on the transaction screen 731. In turn, the rewards management system will pass the merchant and MCC information associated with that card reader (either by pulling that information from the card reader itself if available or by using geolocation services to identify that information) and will send it through the transaction API 741, in the similar manner as in the online transaction illustrated in FIG. 6. Once again, queries against the customer specific MCC table 522, the customer specific retailer table 523, and the customer specific holistic table 521 in FIG. 5 will determine the optimal card to use for the transaction at hand and pass that card's information to the mobile device, where it will be used to conduct the transaction.

The reward optimization card 722 is equipped with an embedded microprocessor that supports encrypted communication with the user's mobile phone, ensuring end-to-end data security. The card 722 captures essential transaction details directly from the Point of Sale (POS) system. This data is then transmitted securely to the backend servers of the rewards management system 700, where its algorithm (such as one implemented in the optimization engine 512 of FIG. 5) determines the most suitable payment method from the user's digital wallet, which may include credit cards, gift cards.

Upon initiating a transaction, the reward optimization card 722 actively retrieves merchant and transaction information from the POS system. This process leverages both a dynamic magnetic stripe and near-field communication (NFC) capabilities, ensuring compatibility with a broad range of existing payment infrastructures. The magnetic stripe on the card 722 is dynamically reprogrammable, adjusting its encoded information in real-time to mimic any selected card from the user's digital wallet, as instructed by the backend server of the rewards management system.

Communication between the card 722 and the user's mobile device is secured using advanced encryption standards. In an exemplary process, the card 722 initially links to the user's account via a secure channel to confirm identity and register the card 722. Subsequently, for each transaction, the card 722 communicates with the mobile phone to establish an encrypted channel, ensuring that all data transmitted, including sensitive payment information, is fully protected.

The use of end-to-end encryption between the rewards optimization card 722 and the mobile phone ensures that all data remains confidential and secure, mitigating potential risks associated with data breaches and fraud. The system also employs dynamic tokenization for each transaction, obfuscating real card numbers with unique identifiers that are meaningless outside of the individual transaction context.

To complement the advanced hardware capabilities, the rewards management system features a user-friendly mobile app that provides users with control and oversight over their accounts. The app allows users to manage their preferences, track spending in real-time, and receive instant updates on the selected payment method for each transaction, thereby enhancing user engagement and trust in the system.

To address the practical challenges associated with device power requirements, the rewards optimization card 722 is designed to minimize the need for frequent recharging. The card harnesses energy from electromagnetic fields generated by POS systems, similar to how passive RFID (Radio Frequency Identification) tags work. This energy harvesting technique allows the card to draw power from the POS during transactions, which it uses to activate its embedded systems and perform necessary data transmission tasks.

In the exemplary embodiment, the technology integrated into the rewards optimization card uses a process known as inductive coupling, found in NFC (Near Field Communication) systems. This method allows the card 722 to receive energy in the form of an induced electrical current generated by the magnetic field of the POS system's NFC reader. This power is sufficient to operate the card's microprocessor and dynamic magnetic stripe during the transaction process, effectively eliminating the need for an internal power source for most transactions.

For situations where NFC or electromagnetic energy harvesting might not be available, such as older POS systems without NFC capabilities, the rewards optimization card 722 includes an ultra-thin, high-capacity rechargeable battery. This battery is designed to be extremely efficient and requires charging only infrequently, supported by a low-energy mode that conserves power when the card is not in active use. Users will be notified on the mobile app when the supplementary power needs charge. In various other embodiments, the reward optimization card 722 is configured to enable photovoltaic charging or wireless charging from contact with a user's phone. The process in this exemplary embodiment is akin to a reverse wireless charging process.

Compared to conventional poly-account cards on the market, where the user manually selects the desired account, the rewards management system intelligently determines the most suitable card account to use in real-time. This ensures that the reward optimization card 722 embodies the optimization output resulting from evaluating factors such as rewards optimization, user-set preferences for certain types of purchases, and user transaction history/cap tracking.

In an alternate embodiment, the reward optimization card 722 functions as a delayed payment tool. In this exemplary embodiment, the reward optimization card 722 is configured to initially approve a transaction in real-time. Subsequently, the optimization engine of the reward management system would, after determining the most optimal user card-account for that particular transaction, post the transaction directly to the selected account or purchasing option.

When a transaction is completed, either via the browser extension or the mobile app, the details of that transaction (Merchant ID, Merchant Category Code, Transaction Amount, Card ID, Transaction Date, Transaction Amount, Reward Rate, and Reward Earned) will be captured in the user transaction table 532. As mentioned previously, upon user request, the app will populate a user's credit card transaction history into the rewards management system to help generate card recommendations for them more quickly. To do this, the system will utilize credit card PDF statement uploads, Excel/CSV uploads, and direct API connections where available to populate this historical information into the database's user transaction table 532.

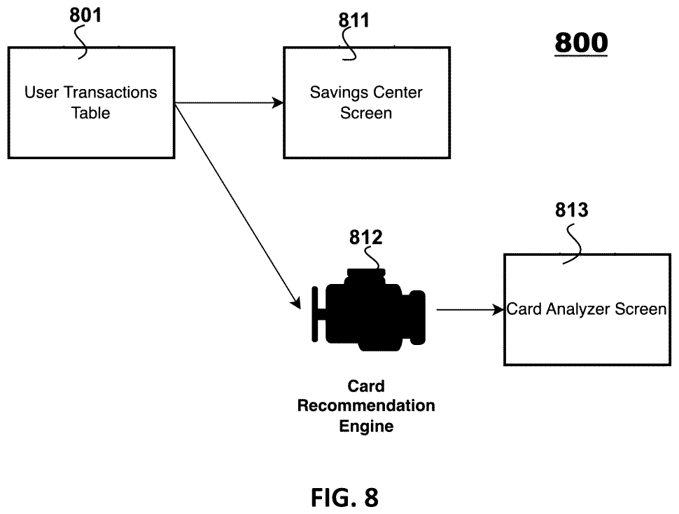

Referring to FIG. 8, with transaction information now populating in the user transaction table 801, it will be able to display the reward value generated for users from using our application. This information will be presented to users on the web and mobile versions of the savings center screen 811. This screen will display metrics on savings earned with the rewards management system over different time periods, rates earned by category, etc. The purpose of this screen is to illustrate the value our offering delivers and to drive goodwill and referrals from said users.

With the retailers and merchant categories a given rewards management system user frequents most in the user transaction table 801, the system will be able to provide the users with bespoke card recommendations for card products that would enhance their reward-earning potential. In order to give these recommendations, the card recommendation engine 812 is configured to track the aggregate spend of users at merchants and by merchant category to recommend cards that are optimal for their specific spending. The users will determine when it is worth it to them to fill out an application and have a hard credit inquiry, and a disclaimer that opening new lines of credit too frequently or for minimal incremental savings may adversely impact their credit scores will be communicated. Soft credit pulls could be used to only recommend cards to those with credit scores that are likely to be accepted. The web and mobile platforms will have a card analyzer screen 813, which will list the cards it recommends a user applies for, why that card would be a good fit for them, and the additional savings they could earn per annum were they to have the card in their wallet.

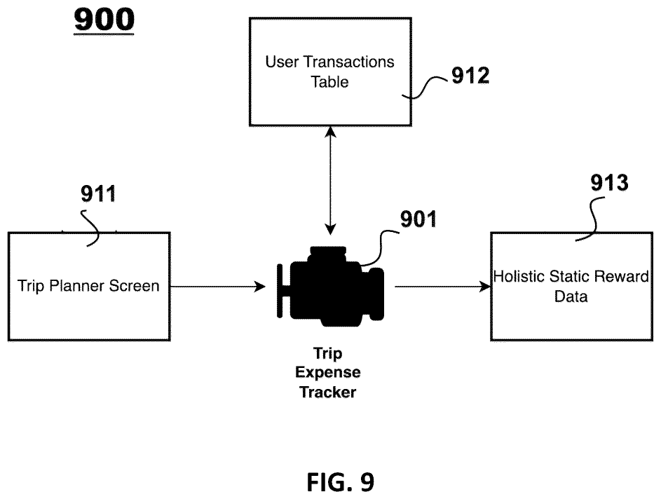

Referring to FIG. 9, the web and mobile offerings will allow users to share their expected upcoming travel expenses. The system can then, using the trip expense tracker 901 along with the data stored in their user transaction table 912, see if there is a card in their wallet that provides outsized points to hotel/airline provider rewards via conversion when compared to the maximum holistic reward rate they would otherwise earn. If so, the system can proxy that holistic card rate with the card that offers the highest point conversion rate in the holistic static reward data 913. For example, a user may have a Chase Freedom card that will earn them the equivalent in Chase points of 1% cash back on all purchases when converted to cash, which is relatively unimpressive. However, when these points are converted to pay for certain flights or hotel options, the converted effective rate is 3.5%, which outperforms most holistic (“X % on all other purchases”) reward rates. With this, if known how much the user plans to spend on upcoming hotel accommodations and flights, the system can use the card that provides the higher effective converted rate up until the rewards earned cover the entirety of that expected travel and hotel expense. This approach will help capture the travel-oriented user segment.

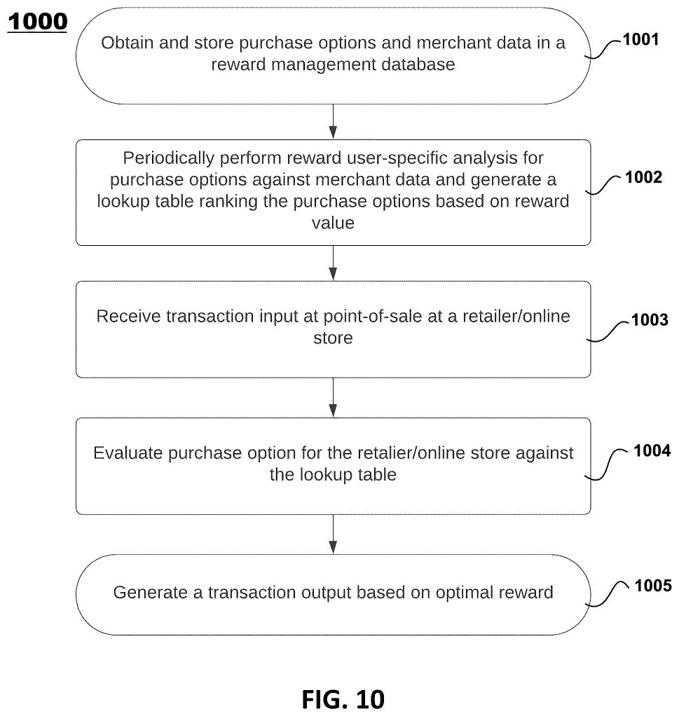

Referring to FIG. 10, an exemplary process utilizing the rewards management system is generally designated 1000. At 1001, purchase options and merchant data are obtained and stored in a reward management database. The purchase options can include credit cards, gift cards, reward programs, etc. Merchant data includes retailer name, merchant classification code (such as merchant category code), transaction classification, etc. The merchant data and purchase options can be sourced using an application programming interface implemented in a mobile apple, web browser extension, standalone software, or more. The merchant data can further be sourced through a sourcing engine or provided by a partnered retailer.

At 1002, user-specific analysis for purchase options is performed periodically against the merchant data. Each purchase option is evaluated by its holistic reward value as well as reward value according to transaction classification and retailer specific reward classification. The analysis is performed periodically, preferably at an inactive period during a user's 24-hour window. A lookup table ranks the purchase options by their holistic reward value, merchant classification reward value, and retailer reward value. The lookup table can be downloaded to a user's local device, such that the remaining process can be carried outside of networked environments.

At 1003, a transaction input is received at a point-of-sale at a retailer or online store. The transaction input can be received by a transaction application programming interface that is designed specifically for the reward management system. In alternative embodiments, the reward management system is integrated into existing transaction-based programs.

At 1004, purchase options for the transaction are evaluated against the lookup table generated at 1002. A purchase option with highest reward potential can be identified during this process.

At 1005, a transaction output is generated based on the optimal reward identified in the previous process. The transaction output is a recommendation in the exemplary embodiment, allowing the user to utilize the proper purchase option (credit card, gift card, etc.) at this transaction. In various other embodiments, the transaction output is a payment hardware configured to embody the optimal purchase option. For example, the transaction output can be in the form of a card wirelessly connected to the reward management system that is able to deliver the chosen purchase option directly. In another embodiment, the transaction output is generated to enable a tap-to-pay function for a smart mobile device.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computer-implemented method for optimizing purchasing rewards, comprising:
obtaining a plurality of purchasing options and storing into a user database,
obtaining merchant data and storing into a merchant database, wherein the merchant data comprises a merchant classification and transaction classification,
analyzing the plurality of purchasing options against the merchant data to produce a reward value for each purchase option against the merchant classification and the transaction classification,
generating, periodically, a lookup table to rank the plurality of purchasing options based on the reward value,
receiving a transaction input, wherein the transaction input comprises a merchant code and a transaction code,
evaluating the transaction input by matching the merchant code against the merchant classification and matching the transaction code with the transaction classification,
identifying an optimized purchasing option from the plurality of purchasing options in the lookup table, wherein the optimized purchasing option comprises the highest reward value, and
generating a transaction output for the optimized purchasing option.

2. The computer-implemented method of claim 1, wherein the lookup table comprises a customer specific holistic table, a customer specific merchant classification code table, and a customer specific retailer table.

3. The computer-implemented method of claim 1, wherein obtaining merchant data further comprises obtaining merchant category code dynamic rewards, merchant category code static rewards, retailer dynamic rewards, user-specific retailer dynamic rewards, retailer static rewards, and holistic rewards.

4. The computer-implemented method of claim 1, further comprising tracking the transaction output in a transaction table, wherein a cap for the reward value of a purchasing option is evaluated against the transaction table.

5. The computer-implemented method of claim 4, wherein the analyzing of the plurality of purchasing options further comprises updating the lookup table based on the cap for the reward value of a purchasing option.

6. The computer-implemented method of claim 1, wherein the analyzing of the plurality of purchasing options further comprises evaluating a holistic reward value for each of the plurality of purchasing options, wherein the holistic reward value is independent of the merchant classification and transaction classification.

7. The computer-implemented method of claim 1, wherein the transaction output is a recommendation of the optimized purchasing option.

8. The computer-implemented method of claim 1, wherein the transaction output is an embodiment of the optimized purchasing option through an output hardware.

9. The computer-implemented method of claim 1, further comprising utilizing an expense tracker to update the lookup table with the merchant classification and transaction classification.

10. The computer-implemented method of claim 1, wherein the generating of the lookup table further comprises downloading the lookup table onto a local device.

11. A system for optimizing purchasing rewards, comprising:
a rewards management system data lake comprising a user database and a merchant database, wherein the user database is configured to store a plurality of purchasing options, and the merchant database is configured to store merchant data, wherein the merchant data comprises a merchant classification and transaction classification,
an optimization engine configured to analyze, periodically, the plurality of purchasing options against the merchant data to produce a reward value for each purchase option against the merchant classification and the transaction classification, and generating, periodically, a lookup table to rank the plurality of purchasing options based on the reward value, and
a transaction application programming interface configured to
receive a transaction input, wherein the transaction input comprises a merchant code and a transaction code,
evaluate the transaction input by matching the merchant code against the merchant classification and matching the transaction code with the transaction classification,
identify an optimized purchasing option from the plurality of purchasing options in the lookup table, wherein the optimized purchasing option comprises the highest reward value, and
generate a transaction output for the optimized purchasing option.

12. The system of claim 11, wherein the optimization engine is further configured to generate, for the lookup table, a customer specific holistic table, a customer specific merchant classification code table, and a customer specific retailer table.

13. The system of claim 11, wherein the merchant database is configured to organize the merchant data based on merchant category code dynamic rewards, merchant category code static rewards, retailer dynamic rewards, user-specific retailer dynamic rewards, retailer static rewards, and holistic rewards.

14. The system of claim 11, wherein the optimization engine further comprises a transaction table configured to track the transaction output, wherein a cap for the reward value of a purchasing option is evaluated against the transaction table.

15. The system of claim 14, wherein the optimization engine is configured to update the lookup table based on the cap for the reward value of a purchasing option.

16. The system of claim 11, wherein the optimization engine is further configured to evaluate a holistic reward value for each of the plurality of purchasing options, wherein the holistic reward value is independent of the merchant classification and transaction classification.

17. The system of claim 11, wherein the transaction API is configured to generate a recommendation of the optimized purchasing option as the transaction output.

18. The system of claim 11, further comprising an output module, wherein the output module is configured to embody the optimized purchasing option.

19. The system of claim 11, wherein the optimization engine further comprise an expense tracker to update the lookup table with the merchant classification and transaction classification.

20. The system of claim 11, wherein the transaction application programming interface is configured to download the lookup table onto a local device.
